(19) United States
(12) Patent Application Publication
(10) Pub. No.: US 2026/0030653 A1
(43) Pub. Date: Jan. 29, 2026

(54) SYSTEMS AND METHODS FOR GENERATING MARKETING CONTENT ATTRIBUTION AND INSIGHTS

(71) Applicant: CLIMATE LLC, St. Louis, MO (US)

(72) Inventors: Michelle FILLA, St. Louis, MO (US); Thomas JEAN, Chicago, IL (US); Cameron TURNER, Palo Alto, CA (US); John OROZCO, Bogotá (CO); Scott HERMES, Reno, NV (US); Steven VLACH, Wheaton, IL (US)

(21) Appl. No.: 19/279,439

(22) Filed: Jul. 24, 2025

Related U.S. Application Data
(60) Provisional application No. 63/675,997, filed on Jul. 26, 2024.

(51) Int. Cl. G06Q 30/0242; G06Q 10/107; G06Q 30/0241

(52) U.S. Cl. CPC G06Q 30/0244; G06Q 10/107; G06Q 30/0276

(57) ABSTRACT

Systems and methods are provided to generate marketing content insights. In one embodiment, a disclosed method includes receiving input data including one or more advertising assets and one or more metrics corresponding to the one or more advertising assets; using a computer vision model, identifying one or more constituent elements of the one or more advertising assets; appending the one or more constituent elements and/or descriptions of the one or more constituent elements to the input data to generate a structured data set; training a generative AI model using the structured data set; training a prediction model using the structured data set; based on the trained generative AI model and a prompt, generating an additional advertising asset not included in the one or more advertising assets; and based on the trained prediction model, generating at least one predicted metric of the additional advertising asset.

### CROSS-REFERENCE TO RELATED APPLICATION

This application claims priority to U.S. Provisional Application No. 63/675,997, filed Jul. 26, 2024, the content of which is incorporated herein by reference in its entirety.

### FIELD

The present disclosure generally relates to the field of marketing analytics, and more particularly relates in various embodiments to systems and methods for leveraging artificial intelligence (AI) models for purposes of generating marketing content attribution and gather insights about marketing materials, as described below.

### BACKGROUND

This section provides background information related to the present disclosure which is not necessarily prior art.

Currently, a typical marketing campaign is a complex endeavor. A typical campaign may use a variety of different marketing assets, including audio, video, images, gifs, text, etc., which all can be variously deployed in a number of different marketing channels, such as print, radio broadcasts, TV broadcasts, social media, etc. Given the complexities of a modern marketing campaign, it has become increasingly difficult to accurately measure the effectiveness of campaigns. Generally, two methods of marketing analytics are known in the art. One is called Marketing Mix Modeling (MMM) and the second is called Multi-Touch Attribution (MTA). MMM is an analytical approach used to quantify the impact of various marketing activities on sales or other performance metrics. By examining historical data, MMM identifies the effectiveness and return-on-investment (ROI) of different components of the marketing mix, such as advertising, promotions, pricing, and distribution channels. This model leverages statistical techniques, such as regression models, to isolate the contribution of each element, allowing marketers to optimize future strategies based on evidence-based insights.

On the other hand, MTA is a method used in digital marketing to evaluate the impact of various touchpoints a consumer encounters on their journey to a purchase or conversion. Unlike traditional models that attribute the entire credit to a single touchpoint (e.g., last-click or first-click attribution), MTA assigns proportional credit to all interactions a consumer has with a brand across multiple channels and devices. This comprehensive approach provides a more accurate understanding of how different marketing efforts contribute to conversion, enabling marketers to optimize their strategies by identifying which channels and tactics are most effective in influencing consumer behavior throughout the entire customer journey.

However, both MMM and MTA suffer from at least two shortcomings. First, insights gained from MMM and MTA are not at the level of granularity of the constituent elements of an ad copy. For example, a print ad for a particular product may have various elements such as the Call-to-Action (CTA), the hero or headline, various objects such as people, animals, equipment, etc., colors, etc. In marketing, the CTA refers to a prompt or instruction that encourages the audience to take a specific, immediate action. This action can range from making a purchase, signing up for a newsletter, downloading a resource, or following a social media account. CTAs are designed to guide potential customers down the sales funnel and are typically framed as direct and compelling phrases such as “Buy Now,” “Sign Up Today,” “Download Free E-book,” or “Learn More.” Currently, how much the performance of a particular ad can be attributed to the CTA versus the headline, for example, is unknowable.

Second, results from MMM, MTA, or other performance analyses of marketing campaigns are typically manually captured in a PowerPoint presentation, which can then be presented in a meeting. But in that case, these marketing insights are not accessible to those not invited to the meeting. Furthermore, these insights can also be lost over time, because the information is only verbally communicated once. Therefore, a need exists in the art for a centralized, queryable database that stores these insights.

The above information is presented as background information only to assist with an understanding of the instant disclosure. No determination has been made, and no assertion is made, as to whether any of the above might be applicable as prior art with regard to the instant disclosure.

### SUMMARY

This section provides a general summary of the disclosure and is not a comprehensive disclosure of its full scope or all of its features.

In one example embodiment, a method for generating marketing content insights includes receiving input data including one or more advertising assets and one or more metrics corresponding to the one or more advertising assets; using a computer vision model, identifying one or more constituent elements of the one or more advertising assets; appending the one or more constituent elements and/or descriptions of the one or more constituent elements to the input data to generate a structured data set; training a generative AI model using the structured data set; training a prediction model using the structured data set; based on the trained generative AI model and a prompt, generating an additional advertising asset not included in the one or more advertising assets; and based on the trained prediction model, generating at least one predicted metric of the additional advertising asset.

In another example embodiment, a system for generating marketing content insights includes at least one processor; a display communicatively coupled to the at least one processor and configured to display a result based on computations performed by the at least one processor; and a memory communicatively coupled to the at least one processor. The memory stores executable instructions, which when executed by the at least one processor, cause the at least one processor to: receive input data including one or more advertising assets and one or more metrics corresponding to the one or more advertising assets; using a computer vision model, identify one or more constituent elements of the one or more advertising assets; append the one or more constituent elements and/or descriptions of the one or more constituent elements to the input data to generate a structured data set; train a generative AI model using the structured data set; train a prediction model using the structured data set; based on the trained generative AI model and a prompt, generate an additional advertising asset not included in the one or more advertising assets and displaying the additional advertising asset on the display; and based on the trained prediction model, generate at least one predicted metric of the additional advertising asset.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram illustrating a computer system upon which embodiments disclosed herein may be implemented;

FIG. 2 is a block diagram illustrating an AI-based system for generating marketing content attribution and insights; and

FIG. 3 illustrates a user interface of the system shown in FIG. 2;

FIG. 4 illustrates one example of the input data 202 shown in FIG. 2;

FIG. 5 illustrates one example of the appended structured data set 208 shown in FIG. 2.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

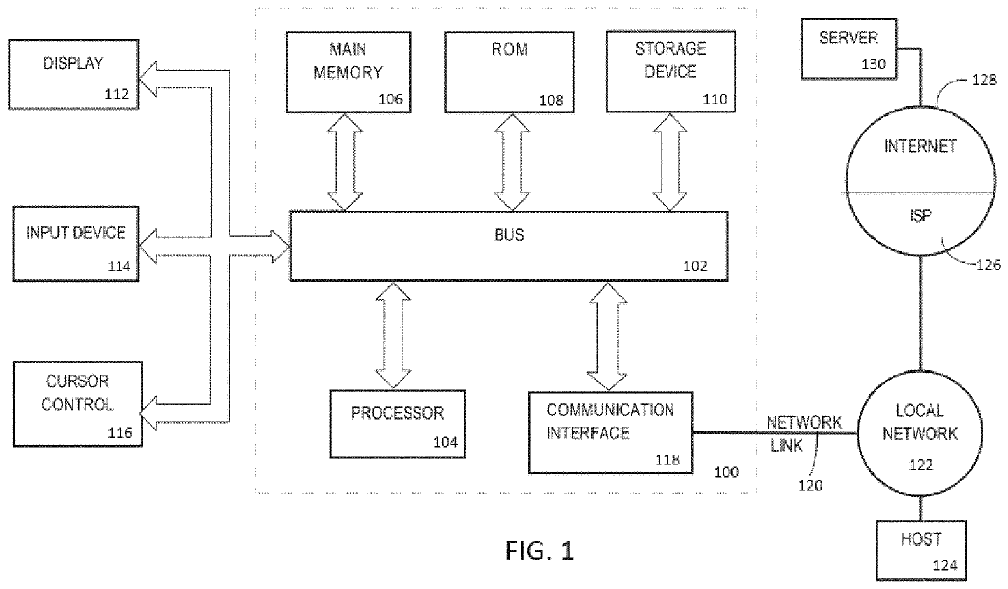

FIG. 1 is a block diagram that illustrates a computer system 100 upon which one or more embodiments of the present disclosure may be implemented. Computer system 100 includes a bus 102 or other communication mechanism for communicating information, and a hardware processor 104 coupled with bus 102 for processing information. Hardware processor 104 may be, for example, a general purpose microprocessor.

Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Such instructions, when stored in non-transitory storage media accessible to processor 104, render computer system 100 into a special-purpose machine that is customized to perform the operations specified in the instructions.

Computer system 100 further includes a read only memory (ROM) 108 or other static storage device coupled to bus 102 for storing static information and instructions for processor 104. A storage device 110, such as a magnetic disk, optical disk, or solid-state drive is provided and coupled to bus 102 for storing information and instructions.

Computer system 100 may be coupled via bus 102 to a display 112, such as a cathode ray tube (CRT), liquid crystal display (LCD), light emitting diode (LED), etc., for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device may, for example, have two degrees of freedom in two axes, a first axis (e.g., x, etc.) and a second axis (e.g., y, etc.), that allows the device to specify positions in a plane. The input device 114, more generally, includes any device through which the user is permitted to provide an input, data, etc., to the computer system 100.

Computer system 100 may implement the techniques described herein using customized hard-wired logic, one or more ASICs or FPGAs, firmware and/or program logic which in combination with the computer system causes or programs computer system 100 to be a special-purpose machine. According to one embodiment, the techniques herein are performed by computer system 100 in response to processor 104 executing one or more sequences of one or more instructions contained in main memory 106. Such instructions may be read into main memory 106 from another storage medium, such as storage device 110. Execution of the sequences of instructions contained in main memory 106 causes processor 104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 110. Volatile media includes dynamic memory, such as main memory 106. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 102. Transmission media can also take the form of acoustic or light waves, such as those generated during radio-wave and infrared data communications.

Various forms of media may be involved in carrying one or more sequences of one or more instructions to processor 104 for execution. For example, the instructions may initially be carried on a magnetic disk or solid-state drive of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infrared signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card, cable modem, satellite modem, or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the Internet 128. Local network 122 and Internet 128 both use electrical, electromagnetic or optical signals that carry digital data streams. The signals through the various networks and the signals on network link 120 and through communication interface 118, which carry the digital data to and from computer system 100, arc example forms of transmission media.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118.

The received code may be executed by processor 104 as it is received, and/or stored in storage device 110, or other non-volatile storage for later execution.

It should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

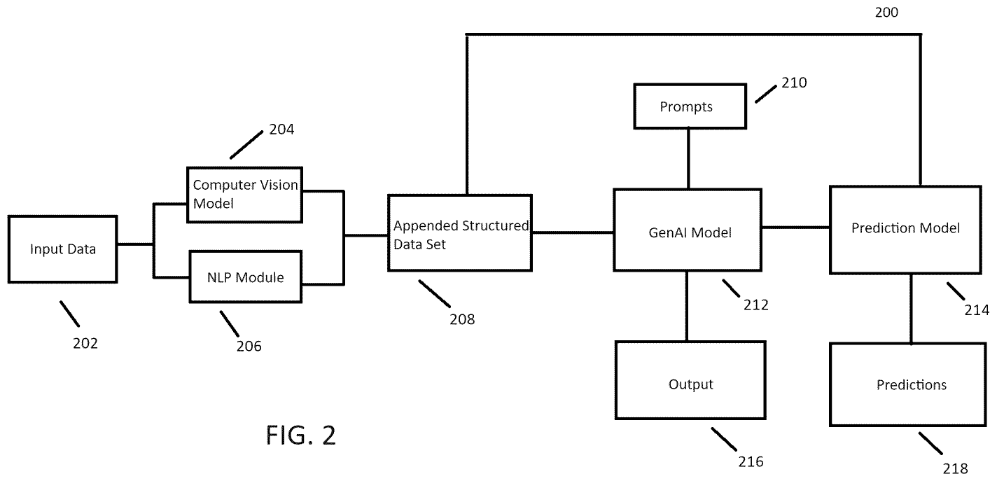

FIG. 2 is a block diagram illustrating an AI-based system 200 for generating marketing content attribution and insights. As explained previously, the AI-based system 200 of FIG. 2 may be implemented on the computer system as shown in FIG. 1, or may be implemented on a plurality of computer systems. For example, a client program implementing a user interface may be stored on and be executing on a local computer system, while the computer vision model 204, the natural language processing (NLP) module 206, the Generative-AI (GenAI) model 212, and the prediction model 214 may be stored on and be executing in one or more remote networked computer systems.

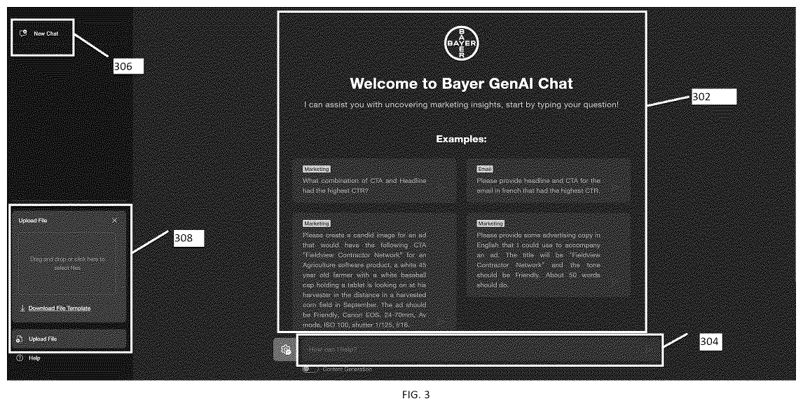

Initially, the user may enter input data 202 into the AI-based system 200 for generating marketing content attribution and insights. FIG. 3 illustrates a user interface of the system via which a user may enter input data. As shown in the figure, the user interface includes a landing page 302, which includes a welcome message and one or more examples in order to orient the user to properly use the AI-based system. The user in turn may enter natural language input into the input box 304. As shown in FIG. 3 in the examples of the landing page 302, one such input may be a query about an existing dataset, such as “what combination of CTA and Headline had the highest CTR?” Another example of an input may be a prompt to generate content, such as text, images, video, audio, etc. As shown in FIG. 3 in the examples of the landing page 302, one such example may be “please create a candid image for an ad that would have the following . . . .”

Further as shown in FIG. 3, the user interface contains a new chat button 306, which allows the user to initiate a new chat session with the AI-based system 200. The user interface also includes an upload dialog 308, from which the user may upload input data 202. The user may either drag-and-drop the input data 202 into the upload dialog 308 to upload the data, or click on the upload dialog 308 to call up a dialog box (for example, a Microsoft Windows dialog box) from which he or she may select the input data 202 file.

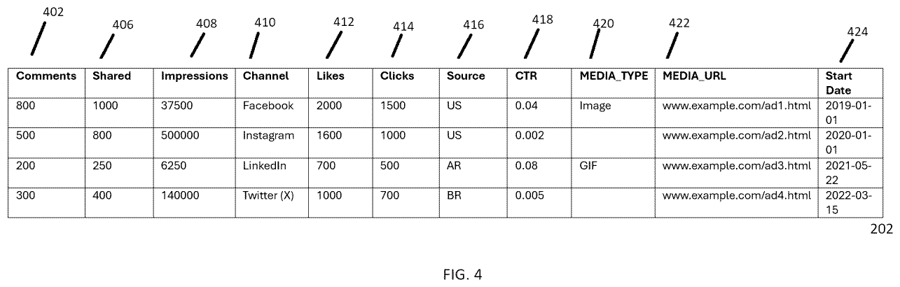

FIG. 4 illustrates one example of the input data 202 shown in FIG. 2. As shown in FIG. 4, the input data 202 can be formatted as a spreadsheet or .csv file that contains information about various pieces of marketing content. In the example shown in FIG. 4, information about four pieces of ad content is shown. The first ad may be an image ad, the third ad may be a Graphics Interchange Format (“gif”) ad, and the second and fourth ads may be text ads. For each piece of ad content, various metrics for the ad are stored in each column of the input data. In the example shown in FIG. 4, column 402 stores the number of comments received by each ad. Column 406 stores the number of times each ad was shared by users of the platform (e.g. Facebook) on which the ad was displayed. Column 408 stores the number of impressions of each ad. That is, the number of times the ad was displayed. Column 410 stores the channel (e.g. platform) on which the ad was displayed, for example Facebook, Instagram, LinkedIn, Twitter (X), etc. Column 412 stores the number of likes received by the ad. Column 414 stores the number of times each ad was clicked upon. Column 416 stores the country information for the ad. In the example shown in FIG. 4, the first and second ads were used in the United States, the third ad was used in Argentina, and the fourth ad was used in Brazil. Column 418 stores the “click-through-rate” (CTR), which is the number of clicks 414 divided by the number of impressions 408. Column 420 stores the image type of the ad. In this embodiment, only whether the ad contains images or gifs is relevant. As a result, the second and fourth ads, which are text ads, have column 420 blank. Column 422 stores a Uniform Resource Locator (URL) from which the ads may be retrieved. As explained below, when the input data 202 is ingested by the computer vision model 204, for example, the computer vision model 204 has subroutines that can retrieve the ad content using the URLs stored in column 422. Finally, column 424 stores the start date of the marketing campaign, i.e., the first day the corresponding ad was displayed on the corresponding platform or channel.

It should be noted that, depending on the nature of the ad or the channel, some boxes of the spreadsheet as shown in FIG. 4 may not have data. For example as shown in the figure and as explained above, because the second and fourth ads are text ads, their MEDIA_TYPE column 420 is blank. As another example, an ad placed on a platform such as Google (not shown), will have columns 402, 406, and 412 blank. This is because users on Google cannot comment on, share, or like ads.

In another embodiment, additional data or columns can be added to the input data 202. These additional fields are shown in the below Table 1.

TABLE 1

| Data Field | Description |
|---|---|
| Engagement | Total number of interactions received (e.g. likes, comments, |
| rate | etc.) divided by total number of followers |
| Summary | High level descriptions of the ad |
| Engagement | Total number of interactions received |
| Type | Type of ad content, e.g. carousel, image, video, story, etc. |
| Topic | Details on the specific ad campaign this ad was created for |
| Reach | Number of individuals in the target audience the ad reached |
| Copy | Copy (i.e. text within the ad/marketing content) |
| Organic | Number of times the content is displayed without paid reach |
| impressions | |
| Region | Domestic region the ad was served (e.g. US state or |
| | Midwest, Northeast, etc.) |
| Paid | Number of times the ad was displayed in channel through |
| impressions | paid efforts |
| Campaign | End date of the campaign |
| end date | |
| Brand | Brand for the product advertised |
| Product | Name of the advertised product |
| Season | What season is the ad representing (e.g. planting/growing/ |
| | harvesting/planning), when the ad is related to an |
| | agricultural product |
| Conversion | Number of converted users from total impressions. A |
| | conversion is a member of the targeted audience |
| | completing an intended action. For example if the ad |
| | encourages purchase of a product and a member of the |
| | targeted audience makes such a purchase, he or she is |
| | a converted user. |
| Ad Cost | Cost of the ad campaign (e.g. in cost-per-mille (CPM)) |
| Creative | Creative agency that came up with the ad |
| Agency | |

The above examples may be applicable for display ads, for example, text- or image-based ads displayed on social media platforms. Another category of ads is email ads, e.g., solicited or unsolicited emails sent directly to users' inboxes. The input data 202 may be different for email ads. In the below Table 2, example input data 202 for email ads are shown.

TABLE 2

| Data Field | Description |
|---|---|
| Name | Name of the email campaign |
| Subject | Subject of the email |
| Unique ID | Unique ID |
| Sent | The number of emails sent |
| Campaign | The campaign the email was part of. The “Campaign” |
| | field is different from the “Name” field in that “Name” |
| | only applies to a specific email campaign, whereas |
| | “Campaign” is the name of the broader marketing |
| | campaign that that email campaign was a part of. |
| Sent From | The email address the email was sent from |
| Delivered | The number of emails delivered |
| Delivery Rate | The delivery rate for the email, i.e. the number of emails |
| | actually delivered divided by the total number of emails |
| | sent. |
| Opens | The number of times the email was opened |
| Open Rate | The open rate for the email, i.e. Opens divided by |
| | Delivered |
| Unique Opens | The unique number of opens for the email |
| Unique clicks | The unique number of clicks for the email |
| Clicks | The number of clicks for the email |
| Click Rate | The click rate for the email, i.e. Clicks divided by |
| | Delivered |
| Click Through | The click through rate for the emails (Total click- |
| Rate | throughs/Open), ex: 0.04. A click is any click on the |
| | email, e.g. a click to open the email, whereas a click- |
| | through is a click on a hyperlink in the email |
| Click-To-Open | The Click-To-Open Rate, i.e. Unique Clicks divided by |
| Rate | Unique Opens |
| Unsubscribed | The number of un-subscription |
| Opt out rate | The Opt Out Rate, i.e. Unsubscribed divided by Sent |
| Spams | The number of times the email was flagged as spam |
| Email link | A Uniform Resource Identifier (URI) link in the email |
| Language | The language of the email (e.g. English, Spanish, etc.) |

Returning to FIG. 2, once the input data 202 is received by the AI-based system 200, the input data 202 may be fed into both the computer vision model 204 and the NLP module 206. The computer vision model 204 may be implemented using GPT-4V™, a computer vision and image analysis model created by OpenAI™. Other examples of computer vision models include DALL-E from OpenAI™, Azure™ AI Vision or OpenCV. The NLP module 206 may be implemented using NLP tools available via Azure™ services created by Microsoft™. Alternatively, the NLP module 206 may also be implemented using other language models such as BERT, ROBERTa, or GPT™.

Using the URL information in column 422 for display ads and in the “Email link” data field for email ads, the computer vision model 204 is able to retrieve copies of the ads. Thus, it should be appreciated that although the input data 202 is structured data, the system disclosed herein is also able to ingest unstructured data such as images via URLs and links embedded in the input data 202. The computer vision model 204 can then analyze the ads to decompose and identify various constituent components of the ads. Specifically, in one embodiment, the computer vision model 204 is able to identify the following elements of the ads:
CTA—the call-to-action of the ad, such as “Sign Up Now”
Headline/Hero (hh)—a short phrase designed to grab the attention of the reader, such as “Ready to Take Your Farm to the Next Level?”
Objects—list of identified objects in the ad
Objects/Extended (objectsext)—extended description of the identified objects in the ad
Colors—two main identified colors in the ad.
Tone—the main identified tone for the ad, such as “friendly,” “serious,” “emotional,” “informational,” “humorous,” “inspirational,” etc.
Summary—a text summary of the ad.
Text—the entire text of the ad

The above elements of the ads may be extracted using the computer vision model 204 by entering the input data 202 into the computer vision model 204, asking the computer vision model 204 to retrieve the ads using the URLs listed in the input data 202, and then prompting the computer vision model 204 as follows:

“Based on retrieved data, always extract the following attributes and elements:
1. Call to Action (CTA) and name it as “CTA”
2. Hero/Headline and name it as “hh”
3. all detected objects in an explained way as list no-bullets, and name it as “objectsext”
4. I need to extract natural elements visible in the image, the tangible items, entities or physical objects you can detect in the image; when you answer this list of objects you need to list only objects in general except: nouns, pronouns, verbs, adjectives, numbers, digits, all determiners, conjunctions, prepositions, and ordinal or cardinal numbers. this list name it as “objects”
5. Two of the most relevant colors used in the background in order of most area covered and name it as “colors”
6. tone (i.e. friendly vs serious) and name it as “tone”
7. Summary and main point of the body text and name it as “summary”
8. Subject line (if not applicable) and name it as “subject”
9. Detect the text you find in the image and name it as “text” (without classify or analyze the detected text).
Answer the question in json format and every attribute must be enclosed as list with [ ].”

Note that the above method of prompting may only apply to display or email ads that contain images, gifs, and/or video. For email ads that do not contain images, for example, prompts 3, 4, and 5 above may be omitted.

When the ad includes gifs, additional processing may be required. An overly large gif file, or a gif that contains too many frames, may render the system overly burdened. Therefore, it is found that when a gif file exceeds a certain size threshold, it may be advantageous to down-sample the gif. The size threshold may be selected based on the needs of the system, e.g. a lower threshold for faster performance, or a higher threshold for preserving more information. In the down-sample process, a filter is used. The filter compares one frame N with the next successive frame N+1 to determine the difference between the frames, e.g. by subtracting the pixel values at corresponding pixels in the frames. If the difference is below a threshold, then the two frames are insufficiently different, and frame N+1 is discarded. Then the same comparison is done with frame N+2 and so on. When the difference exceeds the threshold when comparing frame N with frame N+i, both frames are kept, and the next comparison is done with frame N+i and frame N+i+1. The filter may reduce the gif to less than 10 frames.

Text or words extracted from the ads can also be fed into the NLP module 206. Additional processing may be done using the NLP module 206. For example, as explained above, the computer vision model 204 may generate a list of objects identified in the various ads analyzed by the computer vision model 204. The cumulative list of objects across the entire collection of ads may be, for example, “man,” “woman,” “field,” “sun,” “crops,” “wheat,” “car,” etc. The NLP module 206 may be used to identify the Top N objects by frequency. In one example, the Top 10 objects by frequency may be [tractor, man, tablet, woman, farmer, smartphone, graphic, sky, field, clouds]. The number of Top N objects (i.e., N), may be arbitrarily selected. In this particular embodiment, this list of Top 10 objects may be used as a filter against objects detected in individual ads.

For example, for a first ad, the computer vision model 204 may identify [icon, woman, tablet, house, car]. For a second ad, the computer vision model 204 may identify [tractor, man, notebook, pen]. For a third ad, the computer vision model 204 may identify [sun, crop, iPad]. The objects found in the individual ads may be filtered against the list of the Top 10 objects. The result of the filtering is shown below:
First ad: [woman, tablet]
Second ad: [tractor, man]
Third ad: [ ]

The result of the filtering can also be vectorized. For example, the result of the filtering for the first ad may be represented as [0, 0, 1, 1, 0, 0, 0, 0, 0, 0], with “1” representing the presence of the objects “tablet” and “woman,” and “0” representing the absences of all other objects in the Top 10 objects.

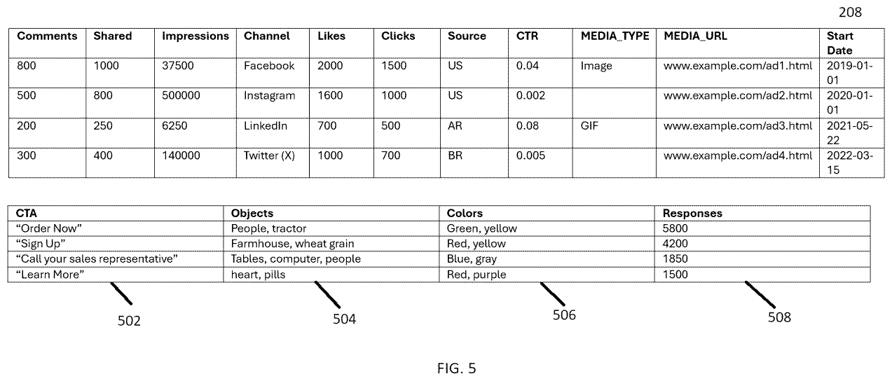

Once the computer vision model 204 generates the json file containing information regarding the elements of the ads as requested by the prompting, data in the json file may be appended to the input data to generate the appended structured data set 208. FIG. 5 illustrates one example of the appended structured data set 208 shown in FIG. 2. As shown in FIG. 5, the input data 202 has been appended with additional data fields 502, 504, 506, and 508. For the sake of simplicity and clarity, only three of the elements identified by the computer vision model 204—the CTA 502, objects 504, and colors 506—are shown in FIG. 5. However, it can be readily understood that all of the other identified elements—hh, objectsext, tone, summary, subject, and text—may have their own field or column in the appended structured data set 208.

For example, the first ad at www.example.com/ad1.html may be an ad prompting users to purchase an agricultural product, such as seeds. The CTA for the ad may be “Order Now,” the ad may show a person in a tractor, and the predominant colors may be green and yellow, i.e., the colors of a corn field.

In one embodiment, the appended structured data set 208 may include an additional field 508 called “Responses.” Responses 508 may be the sum of all interactions with the user, e.g. in the case of social media ads, the sum of all comments, shared, likes, and clicks. The Responses 508 field may not be applicable to other types of ads such as Google ads, as the only way to interact with Google ads is by clicking. Likewise for email ads, there may be a Responses 508 field that contains a count of all clicks by the users once the email is opened.

In yet another embodiment, the appended structured data set 208 may further include an additional field called “Response Rates” (not shown). The Responses Rates field may contain the Responses divided by the number of impressions 408, in the case of social media ads. For email ads, the Response Rates field may be the Responses divided by the number of delivered emails.

Although not shown, the results of the NLP processing may also be appending to the data in the appended structured data set 208. For example, the vector [1, 1, 0, 1, 0, 0, 0, 0, 0, 0] representing the presence of people and tractors in www.example.com/ad1.html may be added to the first row of the appended structured data set 208, when the Top 10 objects list is [tractor, man, tablet, woman, farmer, smartphone, graphic, sky, field, clouds].

Returning to FIG. 2, once the appended structured data set 208 is created, it can then be fed into the GenAI model 212 to train the GenAI model 212. One example of the GenAI model may be ChatGPT™ created by OpenAI™. In this sense, the base version ChatGPT™ trained on data such as Internet data may be said to be fine-tuned by the appended structured data set 208. To perform the fine-tuning, the appended structured data set 208 may be arbitrarily split up into a training dataset and a validation dataset. Once fine-tuned, the GenAI model 212 would gain some understanding of the data in the appended structured data set 208, e.g. via latent-space embeddings. This way, a user may be able to enter natural-language queries into the GenAI model 212 and receive responses that represent insights about the dataset. As mentioned above, one example of such query may be “what combination of CTA and Headline had the highest CTR?” As a response, the GenAI model may output “the combination of ‘Order Now’ and ‘Ready to Take Your Farm to the Next Level?’ generated the highest CTA at 0.07.”

As it is known in the art, the user may also enter prompts into the GenAI model 212 to generate content such as images and video. In one particular example, as shown in FIG. 3, the user may ask “please create a candid image for an ad that would have the follow CTA ‘FieldView Contractor Network’ for an Agriculture software product, a white 45 year old farmer with a white baseball cap holding a tablet is looking on at his harvester in the distance in a harvested corn field in September. The ad should be friendly, Canon EOS, 24-70 mm, Av mode, ISO 100, shutter 1/125, f/16.” The prompt specifies the CTA, objects in the ad (white farmer, baseball cap, tablet, harvester, corn field), the tone (friendly), and camera specifications (Canon EOS, 24-70 mm, Av mode, ISO 100, shutter 1/125, f/16). These camera specifications in the prompt specify the particular look of the image.

As prompted by the above example prompt, the GenAI model may generate an output image 216. But in addition, the appended structured data set 208 may be further fed into a prediction model 214. The prediction model 214 may be based on regression analysis, and for example may be implemented using Azure AutoML™, which is a large, dynamically tuned ensemble model trained using automated machine learning. When the prediction model is trained or fine-tuned by the appended structured data set 208, the AI-based system 200 further has the capability to offer predicted insights for the newly generated ad output 216. For example, with the output 216 generated, the user may ask the GenAI model 212 “what is the predicted CTR for this new ad?” or “how many impressions would this ad be able to get?” Because the training data set, i.e. the appended structured data set 208, includes data about various decomposed constituent elements of existing ads, the GenAI model 212 and the prediction model 214 can provide insights for newly generated ads. In this example, the GenAI model 212 and the prediction model 214 have been trained on data that associates a farmer with a first CTR, baseball cap with a second CTR, a tablet is a third CTR, a harvester with the fourth CTR, a corn field with a fifth CTR, and the tone with the sixth CTR. Therefore, the GenAI model 212 and the prediction model 214 can generate a combined predicted CTR for an ad having all of these elements.

As shown above, one novel advantage of at least one embodiment of the instant disclosure is that a marketer, using the disclosed AI-based system 200, is able to gain insights into various constituent elements of an ad copy or a marketing campaign. For example, the marketer can use natural-language queries to ask about how a particular CTA impacts the campaign or how effective that particular CTA was (e.g. “what's the click-through-rate for the CTA ‘Order Now’?”).

Furthermore, another novel advantage of at least one embodiment of the instant disclosure is that the marketer may be use GenAI to instantly generate new marketing materials, and can use the AI-based system 200 to predict how effective the new marketing materials will be.

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type. Instructions of such computer programs or other software may comprise a set of pages in RAM that contain instructions which, when executed, cause performing one or more functions implementing the systems and methods described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions also may represent one or more files or projects of source code that are digitally stored in a mass storage device, such as non-volatile RAM or disk storage, which when compiled or interpreted cause generating executable instructions which when executed cause the computer system to perform the functions or operations that are described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the steps/operations recited in the claims.

Examples and embodiments are provided so that this disclosure is thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3 8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

In the foregoing description, “model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field may find it convenient to express models using mathematical equations, but that form of expression does not confine the models disclosed herein to abstract concepts; instead, each model herein has a practical application in a computer in the form of stored executable instructions and data that implement the model using the computer.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for generating marketing content insights, comprising:
receiving input data including one or more advertising assets and one or more metrics corresponding to the one or more advertising assets;
using a computer vision model, identifying one or more constituent elements of the one or more advertising assets;
appending the one or more constituent elements and/or descriptions of the one or more constituent elements to the input data to generate a structured data set;
training a generative AI model using the structured data set;
training a prediction model using the structured data set;
based on the trained generative AI model and a prompt, generating an additional advertising asset not included in the one or more advertising assets; and
based on the trained prediction model, generating at least one predicted metric of the additional advertising asset.

2. The method of claim 1, wherein the one or more metrics corresponding to the one or more advertising assets includes at least one of:
a number of comments on each of the one or more advertising assets;
a number of times each of the one or more advertising assets was shared;
a number of impressions made by each of the one or more advertising assets;
a channel of each of the one or more advertising assets;
a number of times each of the one or more advertising assets was liked;
a number of times each of the one or more advertising assets was clicked upon;
a country corresponding to each of the one or more advertising assets;
a click-through-rate for each of the one or more advertising assets;
a media type of each of the one or more advertising assets;
a media Uniform Resource Locator (URL) of each of the one or more advertising assets; and
a start date of each of the one or more advertising assets.

3. The method of claim 2, wherein the structured data set further comprises at least one of:
a response field containing, for each of the one or more advertising assets, a summation of the number of comments, the number of shares, the number of likes, and the number of clicks; and
a response rate field containing, for each of the one or more advertising assets, the response divided by the number of impressions.

4. The method of claim 1, wherein the one or more constituent elements includes at least one of:
a call-to-action (CTA) of each of the one or more advertising assets;
a headline of each of the one or more advertising assets;
objects recognized in each of the one or more advertising assets by the computer vision model;
colors recognized in each of the one or more advertising assets by the computer vision model;
a tone recognized in each of the one or more advertising assets by the computer vision model;
a summary of each of the one or more advertising assets; and
text recognized in each of the one or more advertising assets by the computer vision model.

5. The method of claim 4, further comprising:
using a natural language processing (NLP) module, generating a list of Top N objects across the one or more advertising assets;
filtering the objects identified in each of the one or more advertising assets against the list of Top N objects;
generating vectors corresponding to the filtered objects for each of the one or more advertising assets; and
appending the vectors to the structured data set.

6. The method of claim 5, wherein the NLP module is implemented using Azure™ services, BERT, ROBERTa, or GPT™.

7. The method of claim 1, wherein when the one or more advertising assets includes emails, the one or more metrics corresponding to the one or more advertising assets includes at least one of:
a name of an email campaign;
a subject of the emails;
a number of emails sent;
a number of emails delivered;
a delivery rate of the emails;
a number of times the emails were opened; and
an open rate of the emails.

8. The method of claim 1, wherein the computer vision model identifies the one or more constituent elements in response to a series of prompts entered into the computer vision model by a user.

9. The method of claim 1, wherein when the one or more advertising assets includes a Graphics Interchange Format (gif) file, the method further comprises:
comparing a frame in the gif file with a successive frame; and
discarding the successive frame when the frame and the successive frame are insufficiently different.

10. The method of claim 1, wherein the computer vision model is implemented using GPT-4V™, DALL-E™, and/or Azure™ AI Vision.

11. A system for generating marketing content insights, comprising:
at least one processor;
a display communicatively coupled to the at least one processor and configured to display a result based on computations performed by the at least one processor; and
a memory communicatively coupled to the at least one processor, the memory storing executable instructions, which when executed by the at least one processor, cause the at least one processor to:
receive input data including one or more advertising assets and one or more metrics corresponding to the one or more advertising assets;
using a computer vision model, identify one or more constituent elements of the one or more advertising assets;
append the one or more constituent elements and/or descriptions of the one or more constituent elements to the input data to generate a structured data set;
train a generative AI model using the structured data set;
train a prediction model using the structured data set;
based on the trained generative AI model and a prompt, generate an additional advertising asset not included in the one or more advertising assets and displaying the additional advertising asset on the display; and
based on the trained prediction model, generate at least one predicted metric of the additional advertising asset.

12. The system of claim 11, wherein the one or more metrics corresponding to the one or more advertising assets includes at least one of:
a number of comments on each of the one or more advertising assets;
a number of times each of the one or more advertising assets was shared;
a number of impressions made by each of the one or more advertising assets;
a channel of each of the one or more advertising assets;
a number of times each of the one or more advertising assets was liked;
a number of times each of the one or more advertising assets was clicked upon;
a country corresponding to each of the one or more advertising assets;
a click-through-rate for each of the one or more advertising assets;
a media type of each of the one or more advertising assets;
a media Uniform Resource Locator (URL) of each of the one or more advertising assets; and
a start date of each of the one or more advertising assets.

13. The system of claim 12, wherein the structured data set further comprises at least one of:
a response field containing, for each of the one or more advertising assets, a summation of the number of comments, the number of shares, the number of likes, and the number of clicks; and
a response rate field containing, for each of the one or more advertising assets, the response divided by the number of impressions.

14. The system of claim 11, wherein the one or more constituent elements includes at least one of:
a call-to-action (CTA) of each of the one or more advertising assets;
a headline of each of the one or more advertising assets;
objects recognized in each of the one or more advertising assets by the computer vision model;
colors recognized in each of the one or more advertising assets by the computer vision model;
a tone recognized in each of the one or more advertising assets by the computer vision model;
a summary of each of the one or more advertising assets; and
text recognized in each of the one or more advertising assets by the computer vision model.

15. The system of claim 14, wherein the memory stores further executable instructions that cause the at least one processor to:
using a natural language processing (NLP) module, generate a list of Top N objects across the one or more advertising assets;
filter the objects identified in each of the one or more advertising assets against the list of Top N objects;
generate vectors corresponding to the filtered objects for each of the one or more advertising assets; and
append the vectors to the structured data set.

16. The system of claim 15, wherein the NLP module is implemented using Azure™ services, BERT, ROBERTa, or GPT™.

17. The system of claim 11, wherein when the one or more advertising assets includes emails, the one or more metrics corresponding to the one or more advertising assets includes at least one of:
a name of an email campaign;
a subject of the emails;
a number of emails sent;
a number of emails delivered;
a delivery rate of the emails;
a number of times the emails were opened; and
an open rate of the emails.

18. The system of claim 11, wherein the computer vision model identifies the one or more constituent elements in response to a series of prompts entered into the computer vision model by a user.

19. The system of claim 11, wherein when the one or more advertising assets includes a Graphics Interchange Format (gif) file, the memory stores further executable instructions that cause the at least one processor to:
compare a frame in the gif file with a successive frame; and
discard the successive frame when the frame and the successive frame are insufficiently different.

20. The system of claim 11, wherein the computer vision model is implemented using GPT-4V™, DALL-E™, and/or Azure™ AI Vision.
